(19) United States
(12) Patent Application Publication
(10) Pub. No.: US 2009/0228312 A1
(43) Pub. Date: Sep. 10, 2009

(54) METHOD AND SYSTEM FOR A CALENDARING TOOL FOR CLAIM CODE AND WORKLOAD DETERMINATION

(75) Inventors: John P. Cazares, Indianapolis, IN (US); Nancy Greco, Lagrangeville, NY (US); Charles B. Grizzaffi, Poughquag, NY (US); Sanjay Gupta, Naperville, IL (US); Aditi Jaggi, Epping (AU); Victor P. Lesmana, Jakarta (ID); Jana Palmer, Morristown, AZ (US); Arvin T. Poole, Austin, TX (US); Bharat P. Shah, New Delhi (IN)

Correspondence Address: Cantor Colburn LLP - IBM Endicott, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/042,553

(22) Filed: Mar. 5, 2008

(51) Int. Cl. G06Q 10/00

(52) U.S. Cl. 705/7; 705/1

(57) ABSTRACT

A method for the creation of timesheets, workload management and analysis includes: receiving a set of individual activity entries in the form of task assignments and workload claim codes into a resource and activity planning tool; exporting individual activity entries from the set of individual activity entries to one or more individual user files; populating one or more individual user calendars with entries from the one or more corresponding individual user files; converting the one or more calendar entries into data format files; generating timesheet and workload data from the data format files; uploading the timesheet and workload data into a workload and data warehouse; and providing the timesheet and workload data for analysis.

### BACKGROUND OF THE INVENTION

1. Field of the Invention

This invention relates generally to computer software, and more particularly to a method, article, and system that provides for automatic loading of tasks and activities into a user calendar, updating the calendar entries with workload claim codes, and extraction of user calendar entries for automatic creation of timesheets, and workload management.

2. Description of the Related Art

In the industry today, the collection and analysis of actual time spent with customers and their projects is complicated, time consuming, and manually intensive. Typically, employees calculate the number of hours spent with each customer, or on each project, and subsequently fill out a time sheet either manually or electronically for submission to a master billing and tracking system. In a typical services company, the submitted time sheet is the basis of billing a customer, and thereby is directly related to revenue income for the company. The accuracy of the time spent on a project is critical from both a legal perspective, as well as a resource planning perspective. Inaccuracies in submitted time may lead to incorrect billing, or from a planning perspective, erroneously indicate a surplus or deficit in skilled resources. Both of the previous scenarios impact the bottom line of a business. In some service industries, where consultants visit numerous clients, the time consumed calculating and submitting consultant time sheets has resulted in the definition of a claim code, just for performing this activity. Time entry represents non-productive time for employees and directly impacts the revenue opportunities for the company.

### SUMMARY OF THE INVENTION

Embodiments of the present invention include a method, article, and system for the creation of timesheets, workload management and analysis, the method includes: receiving a set of individual activity entries in the form of task assignments and workload claim codes into a resource and activity planning tool; exporting individual activity entries from the set of individual activity entries to one or more individual user files; populating one or more individual user calendars with entries from the one or more corresponding individual user files; converting the one or more calendar entries into data format files; generating timesheet and workload data from the data format files; uploading the timesheet and workload data into a workload and data warehouse; and providing the timesheet and workload data for analysis.

An article comprising one or more computer-readable storage media containing instructions that when executed by a computer enables a situation based software information development method that maps user roles to a consistent set of tags, wherein the method further includes: receiving a set of individual activity entries in the form of task assignments and workload claim codes into a resource and activity planning tool; exporting individual activity entries from the set of individual activity entries to one or more individual user files; populating one or more individual user calendars with entries from the one or more corresponding individual user files; converting the one or more calendar entries into data format files; generating timesheet and workload data from the data format files; uploading the timesheet and workload data into a workload and data warehouse; and providing the timesheet and workload data for analysis.

A system for the creation of timesheets, workload management and analysis, the system includes: one or more server devices in communication with one or more client devices through a network; the server devices and the client devices configured to execute electronic software; wherein the electronic software is resident on storage mediums in signal communication with the client and server devices; wherein the electronic software comprises a series of instructions configured for: receiving a set of individual activity entries in the form of task assignments and workload claim codes into a resource and activity planning tool; exporting individual activity entries from the set of individual activity entries to one or more individual user files; populating one or more individual user calendars with entries from the one or more corresponding individual user files; converting the one or more calendar entries into data format files; generating timesheet and workload data from the data format files; uploading the timesheet and workload data into a workload and data warehouse; and providing the timesheet and workload data for analysis.

### TECHNICAL EFFECTS

As a result of the summarized invention, a solution is technically achieved for a method, article, and system for providing automatic loading of tasks and activities into user calendars, updating the calendar entries with workload claim codes, and extraction of user calendar entries for automatic creation of timesheets, and workload management.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a functional block diagram for providing automatic loading of tasks and activities into user calendars, updating the calendar entries with workload claim codes, and extraction of user calendar entries for automatic creation of timesheets, and workload management according to embodiments of the invention.

FIG. 2 is a flowchart for implementing a method for providing automatic loading of tasks and activities into user calendars, updating the calendar entries with workload claim codes, and extraction of user calendar entries for automatic creation of timesheets, and workload management according to embodiments of the invention.

FIG. 3 is a block diagram illustrating an exemplary system that may be utilized to implement exemplary embodiments of the invention.

The detailed description explains the preferred embodiments of the invention, together with advantages and features, by way of example with reference to the drawings.

### DETAILED DESCRIPTION

A common practice for employees is to keep a work and event related calendar on a portable, mobile device such as a laptop, cell phone, or other hand held device. Embodiments of the invention are configured to extract information from electronic calendars for conversion to time code reports. Embodiments of the invention utilize the start and stop time of an activity or event entered in a calendar to calculate the number of hours for an activity, and the calculation is then uploaded to a database that enables billing, resource planning, and other user configurable requirements. Embodiments of the invention eliminate time spent for calculating or filling out timesheets (manually or electronically), and offers the ability to automatically and effectively collect data from employee or user calendars into a centralized reporting system, increasing the efficiency and flexibility by which this information may be utilized.

Embodiments of the invention provide a calendaring claims tool that automatically generates timesheet data by pulling employee or user calendar information into a reporting system. The reporting system subsequently breaks down the calendar data by customer, by activity, and by activity work codes. The information may then be sorted by individual, or by grouped department, such that the data can be analyzed to determine billing, workload balance, or work overloads, available free time, as well as being able to automatically pre-determine a list of designated backups for an employee or user based on their skill and availability. The calendaring claims tool is also configured to provide data to project future workload trends, including time availability, that may be used to plan for skill development, training, and other personnel related activities.

Embodiments of the invention are configured to automatically load and store individual time management information on planned and scheduled activities into an individual's software calendar program. Embodiments of the invention are configured with a graphical user interface (GUI) screen to create time keeping claim codes, activity type, and activity codes, which interface with the individual's calendar software to automatically create reports. The resulting reports are defined as timesheets for an employee's activity. In addition, the resulting reports itemize time by claim code, activity, and activity code, and pull available open calendar data to forecast future workload and availability, and provide assignment and notification to predetermined position backup and analysis of workload performed during the reporting period, to determine workload planning, workload management, and customer billing statements.

Embodiments of the invention automatically load information in individual entries about tasks planned and assigned for individual employees or users into an individual employees' or user's calendar. The individual entries in an employees' or user's calendar are identified with workload claim (activity type/category) codes. In addition, embodiments of the invention automatically load the calendar entries along with the claim codes from employees' or user's calendars in to a data format in a data base for calculation of time spent on various claim codes for billing, workload planning, workload analysis, and workload management. Embodiments of the invention automatically generate a timesheet from individual employees' or user's calendar, and automatically forecasts future workload and assess the employees' or user's availability and suitable employee or user back-ups.

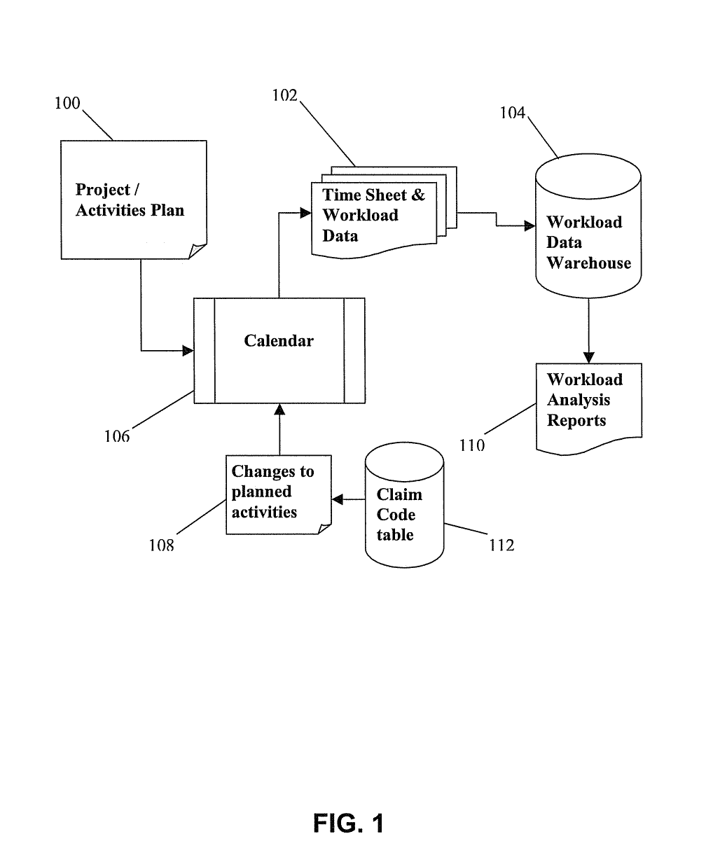

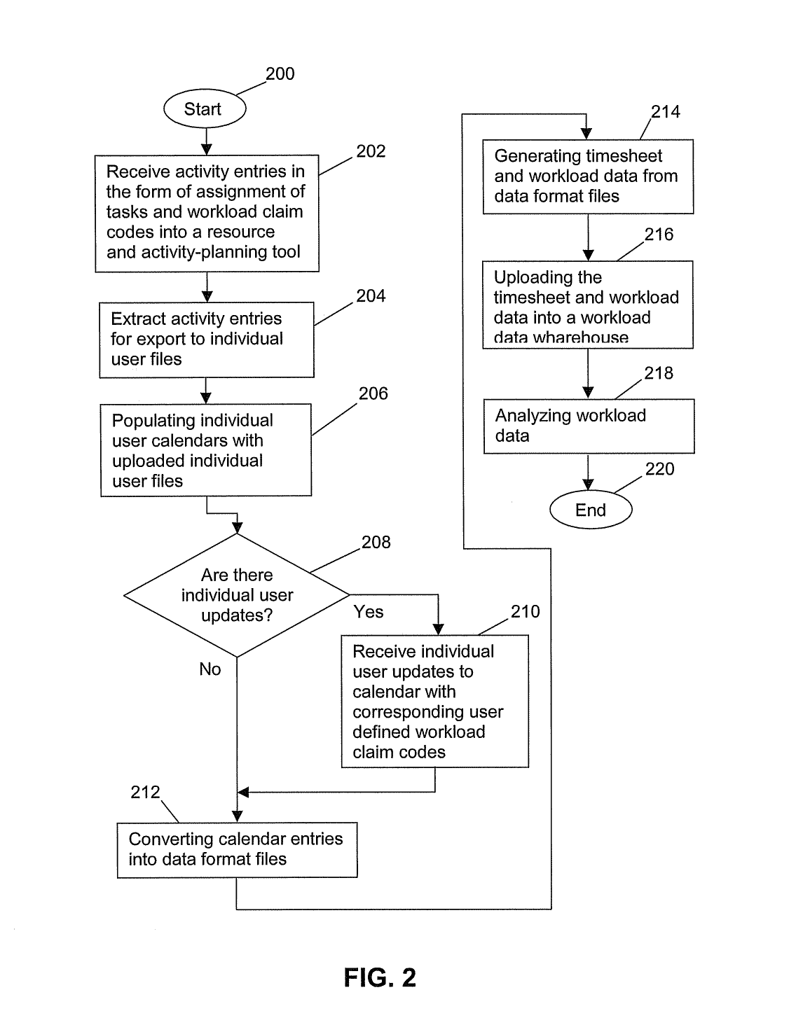

FIGS. 1 and 2 illustrate a functional block diagram and method, respectively, for providing automatic loading of tasks and activities into user calendars, updating the calendar entries with workload claim codes, and extraction of user calendar entries for automatic creation of timesheets, and workload management according to embodiments of the invention.

Referring to FIGS. 1 and 2, a manager or a person in authority starts the process (block 200) by establishing a project/activities plan 100 that finalizes assignments of tasks for their employees (users). The manager updates (received into (block 202)) a resource and activity planning tool with the assigned/planned tasks for their employees. The manager identifies and updates workload claim codes for the activities in the planning tool. The activity entries from the planning tool are extracted (exported) (block 204) into an individual file for every employee or user. All entries in the file contain for every identified activity, an employee id, an activity id, a workload claim code, an activity description, start and end dates, and times. Each of the individual employees or users is then given their activity file for uploading (importing) into their calendar 106. The employee populates their calendar by uploading the file with the planned activities and corresponding workload claim codes (block 206).

In instances where an individual employee or user makes changes or adds new activities or entries 108 to the calendar 106 (decision block 208 is Yes), once the calendar has been populated with the activities (block 206), a workload claim code is assigned by the employee or user from a claim code table 112. The claim code table 112 may be defined and changed by the employee (user), or by a project manager, or human resource administrator that defines the workload claim codes. For each new or changed calendar activity and entry the employee or user chooses a workload claim code from the claim code table 112 (block 210). The claim code table 112 or file, acts as a ready reference for workload claim codes, and saves the employee (user) the time of having to type in a code for each calendar entry.

Timesheet and workload (planned activities) data 102 is generated directly from the calendar 106 entries without requiring the employees or users to do any additional data entry. The calendar 106 entries for a period (day, week, month based on individual project or manager's requirement) are extracted (exported) from the calendar and converted into a data format file (block 212). The data format file is used to create timesheet & workload (planned activities) data 102 (block 214) by accumulating actual & planned time against each different workload claim code during that period. This eliminates, for the employees or users, the manual calculation of hours for each activity in the preparation of timesheet data.

Subsequently, the data from the file with timesheet and workload (planned activities) data 102 is loaded (block 216) into a workload data warehouse 104 for performing various analyses and reporting 110 (block 218). Following the upload of the data from the file with timesheet and workload data 102, the workload data warehouse 104 will have timesheet data for all employees or users with individual entries for time spent during the period for each workload claim code with clear identification of period, employee and their team or manager. In addition, the workload data warehouse 104 also has planned workload data for all employees or users with individual entries for time planned during the period for each workload claim code with clear identification of period, employee and their team or manager.

The timesheet and workload data 102 in the workload data warehouse 104 is used by the managers to perform analysis (block 218) of workload for individual and groups of employees: to analyze actual workload completed by employees; to forecast future workload; to detect and analyze reasons of overloading of employees, if any; to identify possible back-ups for individual employees where there is a change in availability status; to detect and correct imbalance in work assignment among employees in a team; to identify overloaded employees; and to identify free time periods of employees that may be utilized for skills development, or further training.

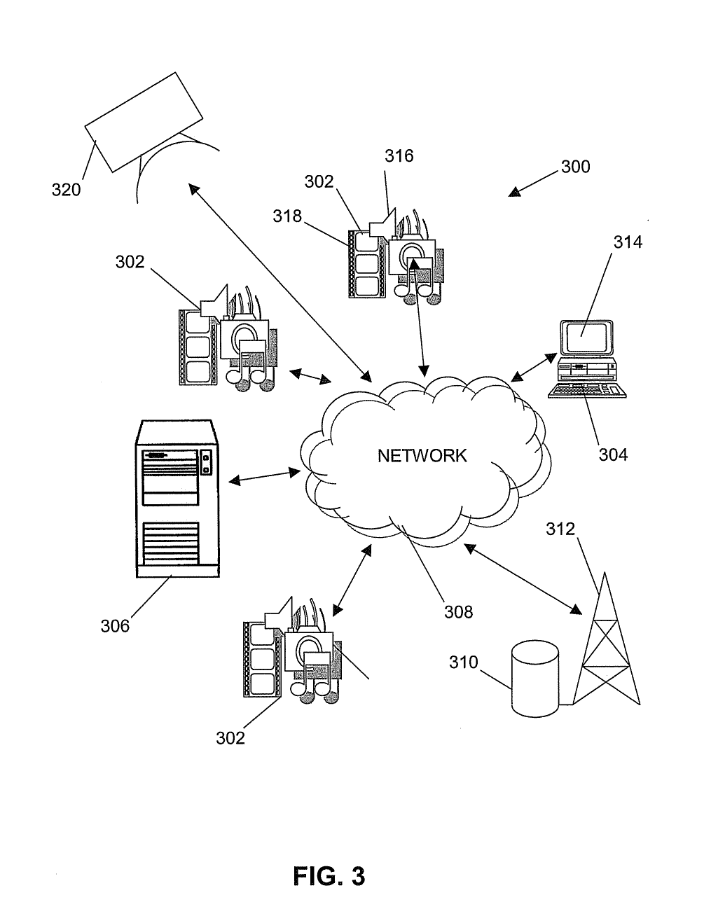

FIG. 3 illustrates an exemplary system 300 for facilitating the automatic loading of tasks and activities into user calendars, updating the calendar entries with workload claim codes, and extraction of user calendar entries for automatic creation of timesheets, and workload management. The system 300 includes remote devices in the form of multimedia devices 302, and desktop computer devices 304 configured with display capabilities 314 for implementing the GUI aspects of the invention described herein. The multimedia devices 302 may be mobile communication and entertainment devices, such as cellular phones and mobile computing devices that are wirelessly connected to a network 308. The multimedia devices 302 have video displays 318 and audio outputs 316 for implanting the GUI described herein. The network 308 may be any type of known network including a fixed wire line network, cable and fiber optics, over the air broadcasts, satellite 320, local area network (LAN), wide area network (WAN), global network (e.g., Internet), intranet, etc. with data/Internet capabilities as represented by server 306. Communication aspects of the network are represented by cellular base station 312 and antenna 310.

User profiles and databases for the calendar and workload aspects of embodiments of the invention may be resident on the individual multimedia devices 302 and desktop computers 304, or stored within the server 306 or cellular base station 310. The software for providing automatic loading of tasks and activities into user calendars, updating the calendar entries with workload claim codes, and extraction of user calendar entries for automatic creation of timesheets, and workload management may be resident on the remote devices (302, 304), the server 306 or cellular base station 310.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for the creation of timesheets, workload management and analysis, the method comprising:
receiving a set of individual activity entries in the form of task assignments and workload claim codes into a resource and activity planning tool;
exporting individual activity entries from the set of individual activity entries to one or more individual user files;
populating one or more individual user calendars with entries from the one or more corresponding individual user files;
converting the one or more calendar entries into data format files;
generating timesheet and workload data from the data format files;
uploading the timesheet and workload data into a workload and data warehouse; and
providing the timesheet and workload data for analysis.

2. The method of claim 1, wherein each of the individual activity entries have at least one of: an employee identification (id), a user id, an activity id, a workload claim code, an activity description, start and end dates, and times.

3. The method of claim 1, wherein the one or more individual users assign a workload claim code, obtained from a claim code table, to changes, added activities, and added new entries to their corresponding individual calendars;
wherein the claim code table is defined and changed by the one or more individual users.

4. The method of claim 1, wherein the time sheet and workload data is automatically generated directly from the one or more individual user calendars without additional data entry by the one or more individual users.

5. The method of claim 1, wherein the analysis of timesheet and workload data further comprises: an analysis of workload completed by the one or more users; a forecast of future workload; an analysis of reasons of overloading of the one or more users; identification of possible back-ups for the one or more users, where there is a change in availability status; detecting and correcting an imbalance in work assignments among the one or more users in a team; identification of overloading among the one or more users; and identification of free time periods among the one or more users.

6. The method of claim 1, wherein a graphical user interface (GUI) is configured to create workload claim codes.

7. An article comprising one or more computer-readable storage media containing instructions that when executed by a computer enables a method for the creation of timesheets, workload management and analysis, wherein the method further comprises:
receiving a set of individual activity entries in the form of task assignments and workload claim codes into a resource and activity planning tool;
exporting individual activity entries from the set of individual activity entries to one or more individual user files;
populating one or more individual user calendars with entries from the one or more corresponding individual user files;
converting the one or more calendar entries into data format files;
generating timesheet and workload data from the data format files;
uploading the timesheet and workload data into a workload and data warehouse; and
providing the timesheet and workload data for analysis.

8. The article of claim 7, wherein each of the individual activity entries have at least one of: an employee identification (id), a user id, an activity id, a workload claim code, an activity description, start and end dates, and times.

9. The article of claim 7, wherein the one or more individual users assign a workload claim code, obtained from a claim code table, to changes, added activities, and added new entries to their corresponding individual calendars;
wherein the claim code table is defined and changed by the one or more individual users.

10. The article of claim 7, wherein the time sheet and workload data is automatically generated directly from the one or more individual user calendars without additional data entry by the one or more individual users.

11. The article of claim 7, wherein the analysis of timesheet and workload data further comprises: an analysis of workload completed by the one or more users; a forecast of future workload; an analysis of reasons of overloading of the one or more users; identification of possible back-ups for the one or more users, where there is a change in availability status; detecting and correcting an imbalance in work assignments among the one or more users in a team; identification of overloading among the one or more users; and identification of free time periods among the one or more users.

12. The article of claim 7, wherein a graphical user interface (GUI) is configured to create workload claim codes.

13. A system for the creation of timesheets, workload management and analysis, the system comprising:
one or more server devices in communication with one or more client devices through a network;
the server devices and the client devices configured to execute electronic software;
wherein the electronic software is resident on storage mediums in signal communication with the client and server devices;
wherein the electronic software comprises a series of instructions configured for:
receiving a set of individual activity entries in the form of task assignments and workload claim codes into a resource and activity planning tool;
exporting individual activity entries from the set of individual activity entries to one or more individual user files;
populating one or more individual user calendars with entries from the one or more corresponding individual user files;
converting the one or more calendar entries into data format files;
generating timesheet and workload data from the data format files;
uploading the timesheet and workload data into a workload and data warehouse; and
providing the timesheet and workload data for analysis.

14. The system of claim 13, wherein each of the individual activity entries have at least one of: an employee identification (id), a user id, an activity id, a workload claim code, an activity description, start and end dates, and times.

15. The system of claim 13, wherein the one or more individual users assign a workload claim code, obtained from a claim code table, to changes, added activities, and added new entries to their corresponding individual calendars;
wherein the claim code table is defined and changed by the one or more individual users.

16. The system of claim 13, wherein the time sheet and workload data is automatically generated directly from the one or more individual user calendars without additional data entry by the one or more individual users.

17. The system of claim 13, wherein the analysis of timesheet and workload data comprises: an analysis of workload completed by the one or more users; a forecast of future workload; an analysis of reasons of overloading of the one or more users; identification of possible back-ups for the one or more users, where there is a change in availability status; detecting and correcting an imbalance in work assignments among the one or more users in a team; identification of overloading among the one or more users; and identification of free time periods among the one or more users.

18. The system of claim 13, wherein a graphical user interface (GUI) is configured to create workload claim codes.
